(19) United States
(12) Patent Application Publication
(10) Pub. No.: US 2025/0346002 A1
(43) Pub. Date: Nov. 13, 2025

(54) METHOD OF MANUFACTURING BEFORE-USE DISSOLUTION INFUSION BAG

(71) Applicant: FUJIFILM Corporation, Tokyo (JP)

(72) Inventors: Yoshiki SAKAZAKI, Minamiashigara-shi (JP); Takashi URABE, Minamiashigara-shi (JP)

(73) Assignee: FUJIFILM Corporation, Tokyo (JP)

(21) Appl. No.: 19/280,498

(22) Filed: Jul. 25, 2025

Related U.S. Application Data
(63) Continuation of application No. PCT/JP2023/045239, filed on Dec. 18, 2023.

(30) Foreign Application Priority Data
Jan. 26, 2023 (JP) 2023-010110

(51) Int. Cl. B29C 65/00; B29L 31/00

(52) U.S. Cl. CPC B29C 66/5326; B29C 66/1122; B29L 2031/7148

(57) ABSTRACT

Provided is a method of manufacturing a before-use dissolution infusion bag in which gas barrier performance of a cover sheet can be prevented from decreasing and a pressing strength required for dissolution before use can be maintained to be low. Provided is a method of manufacturing a before-use dissolution infusion bag, the method including: forming a chamber for sealing a content by performing, two or more times, a sealed portion forming step of laminating two resin sheets and bonding a part of the two resin sheets, in which a thickness difference present in the vicinity of a boundary between two sealed portions that are formed by different sealed portion forming steps and are in contact with each other is 50 μm or less, and a welding step of welding a cover sheet to a region including a boundary portion between the two sealed portions is provided.

### CROSS-REFERENCE TO RELATED APPLICATIONS

This application is a Continuation of PCT International Application No. PCT/JP2023/045239 filed on Dec. 18, 2023, which claims priority under 35 U.S.C. § 119(a) to Japanese Patent Application No. 2023-010110 filed on Jan. 26, 2023. The above applications are hereby expressly incorporated by reference, in their entirety, into the present application.

### BACKGROUND OF THE INVENTION

### 1. Field of the Invention

The present invention relates to a method of manufacturing a before-use dissolution infusion bag.

### 2. Description of the Related Art

A before-use dissolution infusion bag that is used in a medical setting or the like, includes a plurality of chambers, and is partitioned by a partition member such that the plurality of chambers are communicable is known. In the before-use dissolution infusion bag, for example, a drug having hygroscopicity (for example, an antibiotic) and a liquid drug such as a dissolving solution are accommodated in different chambers, and by pressing one chamber before use, the drug and the liquid drug are mixed through the partition member that partitions these chambers.

For example, JP2019-037663A describes that two accommodation parts for accommodating a drug (drug accommodation parts) are provided as a container according to a second embodiment and that a first drug accommodation part and a second drug accommodation part are partitioned by a weak sealed portion having easy peelability and the weak sealed portion is peeled off to mix a first drug and a second drug immediately before use of the drug containers.

### SUMMARY OF THE INVENTION

In this before-use dissolution infusion bag, heat sealing is performed under different conditions for a step of strongly sealing peripheral ends that form a chamber and a step of forming a weak sealed portion that partitions this chamber. In addition, in a part of the peripheral ends, an opening for filling the chamber with a drug is formed, and is heat-sealed and closed after filling the opening with the drug. This opening closing-sealing is performed at a different timing (condition) from that for the strong sealed portion. In addition, the opening closing-sealing is performed after sterilization, and heat is also applied during sterilization. Therefore, heat history of the opening closed-sealed portion is different from that of the strong sealed portion.

Therefore, a difference in thickness (level difference) is likely to occur in each of a boundary portion between the strong sealed portion and the weak sealed portion and a boundary portion between the strong sealed portion and the opening closed-sealed portion.

Incidentally, the before-use dissolution infusion bag is formed of a resin film having low gas barrier properties. In a case where the drug having hygroscopicity (for example, an antibiotic) is accommodated in the chamber of the before-use dissolution infusion bag, the drug or the like may absorb moisture such that the quality is changed. Therefore, a cover sheet having gas barrier properties is welded to an outer surface of the chamber for accommodating the drug or the like of the before-use dissolution infusion bag to use the drug.

Here, according to an investigation by the present inventors, in a case where there is a level difference in the boundary between the sealed portions during welding of a cover sheet, a gap is formed between the cover sheet and a resin film, and there is a concern that sufficient gas barrier performance cannot be obtained. Therefore, it was found that, in order to weld the cover sheet and the resin film with sufficient airtightness, a thermal load needs to be applied at a higher temperature and a higher pressure for a longer time.

However, it was found that, in a case where a thermal load is applied at a high temperature and a high pressure for a long time during the welding of the cover sheet, there may be a problem in that a barrier layer of the cover sheet is fractured such that the gas barrier performance decreases. In addition, it was found that there may be a problem in that heat is applied to the weak sealed portion, the bonding strength increases, and a pressing strength required for communication (dissolution before use) of the weak sealed portion that partitions a chamber for accommodating a drug or the like and a chamber for accommodating a liquid drug increases.

An object of the present invention is to solve the above-described problem of the related art and to provide a method of manufacturing a before-use dissolution infusion bag in which gas barrier performance of a cover sheet can be prevented from decreasing and a pressing strength required for dissolution before use can be maintained to be low.

In order to achieve the object, the present invention has the following configurations.
[1] A method of manufacturing a before-use dissolution infusion bag, the method comprising:
forming a chamber for sealing a content by performing, two or more times, a sealed portion forming step of laminating two resin sheets and bonding a part of the two resin sheets,
in which a thickness difference present in the vicinity of a boundary between two sealed portions that are formed by different sealed portion forming steps and are in contact with each other is 50 μm or less, and
a welding step of welding a cover sheet to a region including a boundary portion between the two sealed portions is provided.
[2] The method of manufacturing a before-use dissolution infusion bag according to [1],
in which one of the two sealed portions is a weak sealed portion and the other sealed portion is a strong sealed portion having a higher bonding strength than the weak sealed portion,
a second sealed portion forming step of forming the strong sealed portion is performed after a first sealed portion forming step of forming the weak sealed portion,
the second sealed portion forming step includes a second heat sealing step and a second cooling step after the second heat sealing step,
in the second cooling step, a region including a region for forming the strong sealed portion is sandwiched in a cooling mold and cooled, and
a clearance in the cooling mold is defined by a thickness of a flat portion of the weak sealed portion.
[3] The method of manufacturing a before-use dissolution infusion bag according to [1],
in which one of the two sealed portions is a strong sealed portion and the other sealed portion is an opening closed-sealed portion, and a third sealed portion forming step of forming the opening closed-sealed portion is performed after a second sealed portion forming step of forming the strong sealed portion,
the third sealed portion forming step includes a third heat sealing step and a third cooling step after the third heat sealing step,
in the third cooling step, a region including a region for forming the opening closed-sealed portion is sandwiched in a cooling mold and cooled, and
a clearance in the cooling mold is defined by a thickness of a flat portion of the strong sealed portion.
[4] The method of manufacturing a before-use dissolution infusion bag according to [1],
in which the two sealed portions are a combination of a weak sealed portion and a strong sealed portion having a stronger bonding strength than the weak sealed portion and a combination of the strong sealed portion and an opening closed-sealed portion, respectively,
a first sealed portion forming step of forming the weak sealed portion, a second sealed portion forming step of forming the strong sealed portion, and a third sealed portion forming step of forming the opening closed-sealed portions are performed in this order,
the second sealed portion forming step includes a second heat sealing step and a second cooling step after the second heat sealing step,
in the second cooling step, a region including a region for forming the strong sealed portion is sandwiched in a second cooling mold and cooled,
a clearance in the second cooling mold is defined by a thickness of a flat portion of the weak sealed portion,
the third sealed portion forming step includes a third heat sealing step and a third cooling step after the third heat sealing step,
in the third cooling step, a region including a region for forming the opening closed-sealed portion is sandwiched in a third cooling mold and cooled, and
a clearance in the third cooling mold is defined by a thickness of a flat portion of the strong sealed portion.
[5] The method of manufacturing a before-use dissolution infusion bag according to [4],
in which the strong sealed portion is formed such that a part of peripheral ends of the two resin sheets is opened,
the opening closed-sealed portion is formed such that the opening of the peripheral ends of the two resin sheets is bonded, and
the weak sealed portion is formed such that a space sealed by the strong sealed portion and the opening closed-sealed portion is partitioned into two regions.

According to the present invention, it is possible to provide a method of manufacturing a before-use dissolution infusion bag in which gas barrier performance of a cover sheet can be prevented from decreasing and a pressing strength required for dissolution before use can be maintained to be low.

### BRIEF DESCRIPTION OF THE DRAWINGS

FIG. 1 is a plan view conceptually showing an example of a before-use dissolution infusion bag prepared using a method of manufacturing a before-use dissolution infusion bag according to the present invention.

FIG. 2 is a cross sectional view taken along line A-A showing the before-use dissolution infusion bag shown in FIG. 1.

FIG. 3 is a perspective view showing the before-use dissolution infusion bag shown in FIG. 1.

FIG. 4 is a conceptual diagram showing the example of the method of manufacturing a before-use dissolution infusion bag according to the present invention.

FIG. 5 is a conceptual diagram showing the example of the method of manufacturing a before-use dissolution infusion bag according to the present invention.

FIG. 6 is a conceptual diagram showing the example of the method of manufacturing a before-use dissolution infusion bag according to the present invention.

FIG. 7 is a conceptual diagram showing the example of the method of manufacturing a before-use dissolution infusion bag according to the present invention.

FIG. 8 is a conceptual diagram showing the example of the method of manufacturing a before-use dissolution infusion bag according to the present invention.

FIG. 9 is a conceptual diagram showing another example of the method of manufacturing a before-use dissolution infusion bag according to the present invention.

FIG. 10 is a conceptual diagram showing another example of the method of manufacturing a before-use dissolution infusion bag according to the present invention.

FIG. 11 is a conceptual diagram showing a second sealed portion forming step in the method of manufacturing a before-use dissolution infusion bag according to the present invention.

FIG. 12 is a cross sectional view taken along line B-B of FIG. 11.

FIG. 13 is a cross sectional view taken along line C-C of FIG. 11.

FIG. 14 is a conceptual diagram showing a second sealed portion forming step in the method of manufacturing a before-use dissolution infusion bag according to the present invention.

FIG. 15 is a cross sectional view taken along line D-D of FIG. 14.

FIG. 16 is a cross sectional view taken along line E-E of FIG. 14.

FIG. 17 is a conceptual diagram showing a second sealed portion forming step in the method of manufacturing a before-use dissolution infusion bag according to the present invention.

FIG. 18 is a cross sectional view taken along line F-F of FIG. 17.

FIG. 19 is a cross sectional view taken along line G-G of FIG. 17.

FIG. 20 is a partially enlarged view showing the vicinity of a boundary between a strong sealed portion and a weak sealed portion in FIG. 19.

FIG. 21 is a conceptual diagram showing a third sealed portion forming step in the method of manufacturing a before-use dissolution infusion bag according to the present invention.

FIG. 22 is a cross sectional view taken along line H-H of FIG. 21.

FIG. 23 is a conceptual diagram showing a third sealed portion forming step in the method of manufacturing a before-use dissolution infusion bag according to the present invention.

FIG. 24 is a cross sectional view taken along line I-I of FIG. 23.

FIG. 25 is a conceptual diagram showing the third sealed portion forming step in the method of manufacturing a before-use dissolution infusion bag according to the present invention.

FIG. 26 is a cross sectional view taken along line J-J of FIG. 25.

FIG. 27 is a partially enlarged view showing the vicinity of a boundary between an opening closed-sealed portion and the strong sealed portion in FIG. 26.

FIG. 28 is a conceptual diagram showing another example of the second sealed portion forming step.

FIG. 29 is a conceptual diagram showing another example of the third sealed portion forming step.

FIG. 30 is a partially enlarged view showing the vicinity of a boundary in a case where the strong sealed portion is hot-pressed.

FIG. 31 is a partially enlarged view showing the vicinity of a boundary in a case where the strong sealed portion is hot-pressed.

### DESCRIPTION OF THE PREFERRED EMBODIMENTS

Hereinafter, a method of manufacturing a before-use dissolution infusion bag according to an embodiment of the present invention will be described in detail based on preferred examples shown in the accompanying drawings.

In the present invention, numerical ranges represented by “to” include numerical values before and after “to” as lower limit values and upper limit values.

### [Before-Use Dissolution Infusion Bag]

First, a configuration of a before-use dissolution infusion bag prepared using the method of manufacturing a before-use dissolution infusion bag according to the embodiment of the present invention will be described.

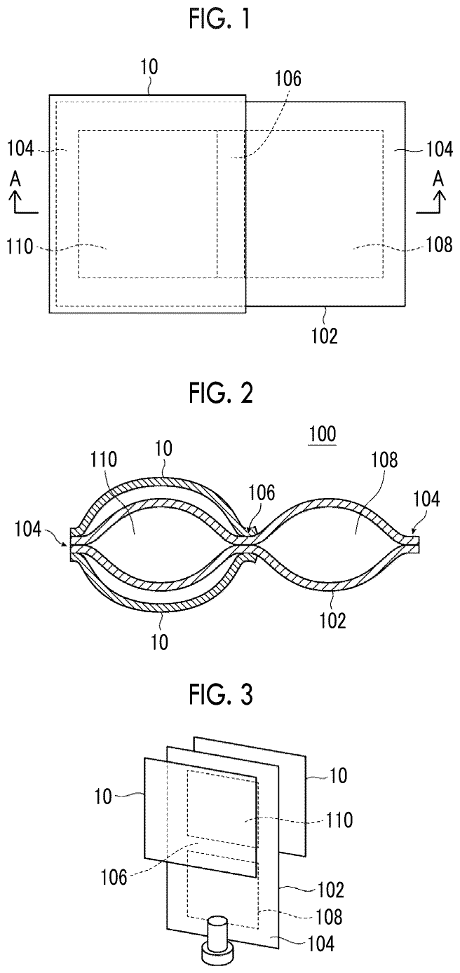

FIG. 1 is a top view conceptually showing an example of the before-use dissolution infusion bag prepared using the method of manufacturing a before-use dissolution infusion bag according to the embodiment of the present invention. FIG. 2 is a cross sectional view taken along line A-A showing the before-use dissolution infusion bag shown in FIG. 1. FIG. 3 is a perspective view showing the before-use dissolution infusion bag shown in FIG. 1. In FIG. 3, a resin bag 102 and a cover sheet 10 are separated from each other for convenience of description.

A before-use dissolution infusion bag 100 shown in FIGS. 1 to 3 includes a resin bag (infusion bag, bag body) 102 and two cover sheets 10. In addition, although not shown in FIGS. 1 and 2, the before-use dissolution infusion bag 100 includes a port 112 connected to one chamber 108 as a liquid discharge port.

In the before-use dissolution infusion bag 100, the resin bag 102 and the cover sheet 10 are bonded to each other by thermal welding (heat sealing) through a sealant layer. In addition, in the example shown in the drawing, peripheral portions of the resin bag 102 and the cover sheets 10 are bonded to form a space therebetween.

### [Resin Bag]

As shown in FIGS. 1 to 3, the resin bag 102 is a bag where peripheral ends of two resin films are joined through a strong sealed portion 104 and an opening closed-sealed portion 105 or a bag where one resin film is folded and peripheral ends are joined through the strong sealed portion 104 and the opening closed-sealed portion 105. The strong sealed portion 104 and the opening closed-sealed portion 105 through which the peripheral ends of the resin films are joined is a sealed portion for isolating a chamber of the resin bag 102 and the outside from each other.

Although described in detail below, a part of the strong sealed portion 104 through which the peripheral ends of the resin films are bonded is formed such that an opening for filling the chamber 110 with a drug is provided, and after filling the chamber 110 with the drug, the opening is heat-sealed to form an opening closed-sealed portion 105. The opening closed-sealed portion 105 is formed at a timing different from that of the strong sealed portion 104. The formed opening closed-sealed portion 105 functions as a sealed portion for joining the peripheral ends of the resin films as in the strong sealed portion 104 to isolate the chamber of the resin bag 102 from the outside. Accordingly, sealing performance required for the opening closed-sealed portion 105 is the same as that of the strong sealed portion.

In addition, as shown in FIGS. 1 to 3, the resin bag (bag body) 102 includes two chambers 108 and 110, and the two chambers are partitioned by a weak sealed portion (partition member) 106. In addition, the weak sealed portion 106 is a sealed portion having a weaker bonding strength than the strong sealed portion 104 and the opening closed-sealed portion 105 where the peripheral ends of the resin films are joined. In the example shown in FIG. 2, all of the peripheral ends of the two resin films substantially having a rectangular shape are joined through the strong sealed portion 104 and the opening closed-sealed portion 105 to form an inner space. In FIG. 2, the inner space is separated into the two chambers 108 and 110 by the weak sealed portion 106 extending from the strong sealed portion 104 on an upper end side to the strong sealed portion 104 on a lower end side.

Examples of a material of the resin bag 102 (resin film) include a resin film such as a polyethylene resin or a polypropylene resin. In addition, in the case of the bag where two resin films are joined, the two resin films may be films consisting of different materials and are preferably films consisting of the same material. In a case where the films consisting of the same material are bonded to each other using a heat sealing method, the films can be easily bonded to each other.

The thickness of the resin film of the resin bag 102 is preferably 20 to 200 μm.

The strong sealed portion 104 (opening closed-sealed portion 105) and the weak sealed portion 106 can be formed using a heat sealing method.

In addition, a method of forming the weak sealed portion 106 is not particularly limited as long as the weak sealed portion 106 has a weaker bonding strength than the strong sealed portion 104. By changing conditions (a temperature, a pressing strength, and the like) during heat sealing during the formation of the strong sealed portion 104, the weak sealed portion 106 having a weaker bonding strength may be formed. By heat-sealing the two resin films with different kinds of resin layers interposed therebetween at a position where the weak sealed portion 106 is formed, the weak sealed portion 106 may have a weaker bonding strength than the strong sealed portion 104. By scattering the strong sealed portions having a small area that can be fractured in an airtightly closed region, the weak sealed portion 106 having a sea-island structure that exhibits the same weak sealing function in a macro manner may be formed.

The bonding strengths of the strong sealed portion 104 (opening closed-sealed portion 105) and the weak sealed portion 106 may be adjusted to be in well-known ranges in the related art. As described in JIS Z 0238:1998, the bonding strength of the strong sealed portion 104 is preferably 23 N/15 mm or more, and the bonding strength of the weak sealed portion 106 is preferably 3 N/15 mm or less.

In the resin bag 102, typically, peripheral ends (end parts) of the resin film other than a necessary outlet (for example, a liquid discharge port (port 112) of an infusion bag) may be completely joined.

The kind of the resin bag (bag body) 102 is preferably used for packaging a product that requires gas barrier properties. Examples of the product to be packaged include food, non-food, and chemical. The state of the product to be packaged may be liquid, solid, or powdered. It is preferable that, by appropriately performing heat sealing, the packaging material is bag-shaped. Specific examples of the packaging material include a packaging bag for food, a packaging bag for chemical, and an infusion bag.

### (Infusion Bag)

In a case where the resin bag 102 is an infusion bag, for example, one chamber 108 accommodates a liquid drug such as a dissolving solution, and the other chamber 110 accommodates a drug having hygroscopicity (for example, an antibiotic). In this case, the cover sheet 10 is bonded to an outer side surface of the chamber 110 for accommodating a drug having hygroscopicity.

In the infusion bag, the weak sealed portion 106 is peeled off immediately before use, the liquid drug and the drug are mixed, and the mixture is infused from the liquid discharge port.

Examples of the drug used in the infusion bag include liquid to be administered under the skin or into the blood vessel or abdominal cavity by drip infusion or the like. In the case of the duplex bag, examples of the drug include powdered drug and liquid such as saline. Examples of the powder drug include a nutrient such as vitamin or amino acid, an antibiotic, and an antibacterial agent.

In addition, within a range not departing from the scope of the present invention, techniques described in JP2003-230618A and JP1998-201818A (JP-H10-201818A) can be considered.

### [Cover Sheet]

The cover sheet 10 is a film-shaped member having gas barrier properties. The cover sheet 10 is bonded to at least one of the outer side surfaces of the chamber 110 for accommodating the drug or the like having hygroscopicity in the resin bag 102, that is, the surfaces of the resin film opposite to the chamber 110. In addition, as shown in FIG. 1, it is preferable that a peripheral end of the cover sheet 10 is bonded to the resin film. That is, the cover sheet 10 is bonded to regions of the strong sealed portion 104, the opening closed-sealed portion 105, and the weak sealed portion 106 in the resin bag 102. As a result, the drug or the like having hygroscopicity can be prevented from absorbing moisture, and the quality can be prevented from being changed.

As the cover sheet 10, a well-known cover sheet that can be used for a before-use dissolution infusion bag in the related art can be appropriately used.

Examples of the cover sheet 10 include a metal foil such as aluminum foil, a laminated film where a metal layer such as aluminum is formed on a resin film, and a gas barrier film such as silicon nitride or silicon oxide where an inorganic layer and an organic layer are laminated described in JP2015-171798A, JP2014-024602A, and the like.

In addition, in a case where the two cover sheets 10 are bonded to both of the outer side surfaces of the chamber 110 of the resin bag 102, respectively, the two cover sheets 10 may be the same kind of films or may be different kinds of films. From the viewpoint that the inside of the chamber 110 is visible, one cover sheet 10 is preferably a gas barrier film where an inorganic layer and an organic layer are laminated.

The sealant layer (thermal welding layer) is bonded to the cover sheet 10, and the cover sheet 10 is bonded to the resin bag 102 by heat sealing (thermal welding (thermal fusion)).

### <Sealant Layer>

The sealant layer is a layer for bonding the cover sheet 10 to an object by heat sealing (thermal welding (thermal fusion)).

Basically, the sealant layer is formed of the same forming material as the object to which the cover sheet is heat-sealed. For example, in a case where the object is an infusion bag, the sealant layer is formed of the same material as the material for forming the infusion bag. That is, in a case where the object to be heat-sealed is formed of polyethylene (PE), a sheet-shaped material (film-shaped material) formed of PE may be used as the sealant layer, and in a case where the object to be heat-sealed is formed of polypropylene (PP), a sheet-shaped material (film-shaped material) formed of PP may be used as the sealant layer.

Specifically, as the material for forming the sealant layer, a resin film described in paragraph of JP2012-075716A can be used.

In addition, the thickness of the sealant layer is not also limited, and may be appropriately selected depending on the material for forming the sealant layer and the shape, state, or the like of the object such as an infusion bag to be heat-sealed such that the object can be reliably thermally welded. Here, according to the study by the present inventors, the thickness of the sealant layer is preferably 5 to 150 μm, more preferably 10 to 100 μm, and still more preferably 30 to 70 μm. The thickness of the sealant layer is preferably 5 μm or more from the viewpoints that, for example, more reliable heat sealing can be performed and unevenness of a surface of the object to be heat-sealed can be suitably absorbed. The thickness of the sealant layer is preferably 150 μm or less from the viewpoints that, for example, the thickness of the before-use dissolution infusion bag can be reduced and permeation of water vapor and/or oxygen from a side surface of the sealant layer during thermal welding of the infusion bag or the like can be more effectively suppressed.

### <Adhesive Layer>

An adhesive layer is a layer for bonding the sealant layer and the cover sheet 10.

As the adhesive layer, all of well-known adhesives through which the sealant layer can adhere to the cover sheet 10 can be used.

In addition, the thickness of the adhesive layer is not limited, and may be appropriately selected such that the sealant layer can reliably adhere to the cover sheet 10.

### [Method of Manufacturing Before-Use Dissolution Infusion Bag].

A method of manufacturing a before-use dissolution infusion bag according to the embodiment of the present invention, comprises:
forming a chamber for sealing a content by performing, two or more times, a sealed portion forming step of laminating two resin sheets and bonding a part of the two resin sheets,
in which a thickness difference present in the vicinity of a boundary between two sealed portions that are formed by different sealed portion forming steps and are in contact with each other is 50 μm or less, and
a welding step of welding a cover sheet to a region including a boundary portion between the two sealed portions is provided.

The method of manufacturing a before-use dissolution infusion bag according to the embodiment of the present invention (hereinafter, also referred to as the manufacturing method according to the embodiment of the present invention) will be described.

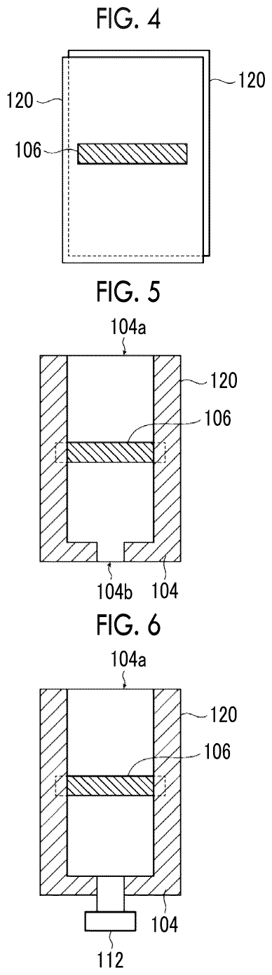

First, all the flows of the method of manufacturing a before-use dissolution infusion bag will be described using FIGS. 4 to 10.

In FIGS. 4 to 10, an example of forming a before-use dissolution infusion bag using two resin films 120 having a substantially rectangular shape will be described.

As shown in FIG. 4, two resin films 120 are laminated to form the weak sealed portion 106 in a region extending from one side toward the other side of substantially the center portion, the sides facing each other in the left-right direction. A method of forming the weak sealed portion 106 is as described above.

Next, as shown in FIG. 5, the strong sealed portion 104 is formed in a partial region of the peripheral ends of the two resin films 120. In the example shown in the drawing, the upper end side in the drawing that is an opening 104a and substantially the center portion of the lower end side in the drawing that is a port insertion hole 104b are not heat-sealed, and the remaining portion (region along the left and right end sides and a part of the lower end side in FIG. 5) is heat-sealed. As a result, the strong sealed portion 104 is formed. That is, in this step, a space that functions as one chamber (chamber on the upper side in FIG. 5) partitioned by the weak sealed portion 106 is open through the opening 104a, and a space that functions as the other chamber (chamber on the lower side in FIG. 5) is open through the port insertion hole 104b.

In addition, as shown in FIG. 5, the strong sealed portion 104 is formed such that a part thereof overlaps the weak sealed portion 106. As a result, the two chambers can be reliably partitioned by the weak sealed portion 106.

In a case where the two resin films are directly heat-sealed to each other, the region where the strong sealed portion 104 and the weak sealed portion 106 overlap each other acts as the strong sealed portion 104 to be subsequently formed, and thus is considered the strong sealed portion 104. On the other hand, in a case where the weak sealed portion 106 is formed such that different kinds of resin layers are interposed between the two resin films, a region where different kinds of resin layers are interposed is considered the weak sealed portion 106, and a region where the resin layer is not provided is considered the strong sealed portion 104.

Next, as shown in FIG. 6, the port 112 is inserted into the port insertion hole 104b to join the port 112. The port 112 is communicable with the chamber on the lower side in FIG. 6, and a liquid can be injected and discharged. As the port 112, a well-known port (liquid discharge port) in the related art that is used for a before-use dissolution infusion bag can be appropriately used. In addition, as a method of joining the port 112, a method of joining a port that is performed for a before-use dissolution infusion bag in the related art can be appropriately performed. Examples of the joining method include heat sealing. In addition, for example, a method of providing a claw structure to lock and join a port or a joining method of fixing a port by fastening a screw can be used. In this case, it is preferable that airtightness is ensured by joining through a sealing member such as an O-ring or a seal tape.

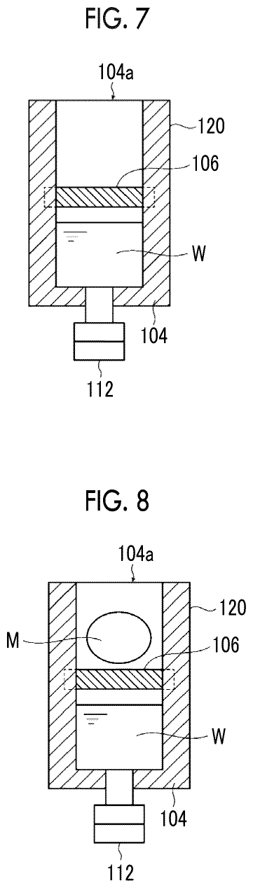

Next, as shown in FIG. 7, a chemical liquid W is injected into the chamber 108 via the joined port 112, and then the port is closed.

In addition, a sterilization treatment may be performed before injecting the chemical liquid W after injecting the chemical liquid W into the chamber 108 or after connecting the port 112. Examples of the sterilization treatment include a well-known sterilization method in the related art that is performed in the manufacturing of a before-use dissolution infusion bag, for example, sterilization by high-pressure steam, sterilization by hydrogen peroxide gas, electron beam sterilization, or gamma sterilization.

Next, as shown in FIG. 8, the inside of the chamber 110 is filled with a drug M from the opening 104a.

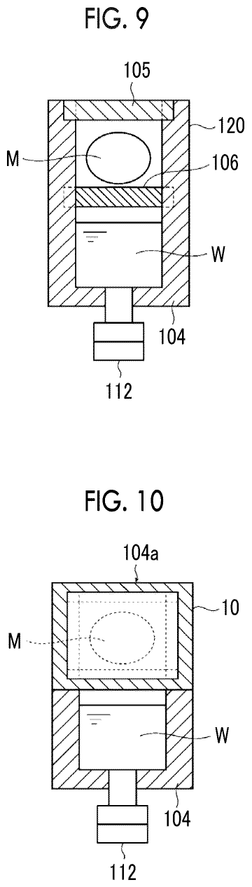

After filling the drug M, as shown in FIG. 9, the opening 104a is heat-sealed to form the opening closed-sealed portion 105. As a result, the chamber 110 filled with the drug M is sealed.

In addition, as shown in FIG. 9, the opening closed-sealed portion 105 is formed such that a part thereof overlaps the strong sealed portion 104. As a result, the chamber 110 and the outside can be reliably isolated from each other.

In addition, a region where the strong sealed portion 104 and the opening closed-sealed portion 105 overlap each other is considered the opening closed-sealed portion 105 to be subsequently formed.

Next, as shown in FIG. 10, the cover sheet 10 is bonded to an outer surface of the chamber 110 filled with the drug M. As described above, the peripheral end of the cover sheet 10 is welded to the resin bag 102. That is, as in a region 130 indicated by a diagonal line in FIG. 10, the region 130 where the cover sheet 10 and the resin bag 102 are welded overlaps the strong sealed portion 104, the opening closed-sealed portion 105, and the weak sealed portion 106.

From the above, a before-use dissolution infusion bag is prepared.

Here, the method of manufacturing a before-use dissolution infusion bag according to the embodiment of the present invention comprises: forming a chamber for sealing a content by performing, two or more times, a sealed portion forming step of laminating two resin films 120 and bonding a part of the two resin films 120, in which a thickness difference present in the vicinity of a boundary between two sealed portions that are formed by different sealed portion forming steps and are in contact with each other is 50 μm or less, and a welding step of welding a cover sheet 10 to a region including a boundary portion between the two sealed portions is provided.

In the above-described example, a step of forming the weak sealed portion 106 (FIG. 4), a step of forming the strong sealed portion 104 (FIG. 5), and a step of forming the opening closed-sealed portion 105 (FIG. 9) corresponds to the sealed portion forming step. In addition, the weak sealed portion 106 and the strong sealed portion 104 correspond to the two sealed portions, and the strong sealed portion 104 and the opening closed-sealed portion 105 correspond to the two sealed portions. That is, in the above-described example, a thickness difference present in the vicinity of a boundary between the weak sealed portion 106 and the strong sealed portion 104 is 50 μm or less, and a thickness difference present in the vicinity of a boundary between the strong sealed portion 104 and the opening closed-sealed portion 105 is 50 μm. As shown in FIG. 10, the cover sheet 10 is welded to cross the boundary portions.

As described above, in a case where there is a level difference in the vicinity of the boundary between the sealed portions during welding of a cover sheet, a gap is formed between the cover sheet and a resin film, and there is a concern that sufficient gas barrier performance cannot be obtained. Therefore, in order to weld the cover sheet and the resin film with sufficient airtightness, a thermal load needs to be applied at a higher temperature and a higher pressure for a longer time. However, it was found that, in a case where a thermal load is applied at a high temperature and a high pressure for a long time during the welding of the cover sheet, there may be a problem in that a barrier layer of the cover sheet is fractured such that the gas barrier performance decreases. In addition, it was found that there may be a problem in that heat is applied to the weak sealed portion, the bonding strength increases, and a pressing strength required for communication (dissolution before use) of the weak sealed portion that partitions a chamber for accommodating a drug or the like and a chamber for accommodating a liquid drug increases.

On the other hand, in the manufacturing method according to the embodiment of the present invention, by setting the thickness difference present in the vicinity of the boundary of the two sealed portions in contact with each other to be 50 μm or less, that is, by setting the thickness difference present in the vicinity of the boundary between the weak sealed portion 106 and the strong sealed portion 104 to be 50 μm or less, and/or by setting the thickness difference present in the vicinity of the boundary between the strong sealed portion 104 and the opening closed-sealed portion 105 to be 50 μm, a thermal load required for welding the cover sheet and the resin film with sufficient airtightness can be reduced. Therefore, a decrease in gas barrier performance caused by fracture of a barrier layer of the cover sheet can be prevented. In addition, an increase in bonding strength caused by application of heat to the weak sealed portion can be prevented, and a pressing strength required for dissolution before use can be maintained to be low.

Here, from the viewpoint of suppressing a decrease in the gas barrier performance of the cover sheet 10 and maintaining a pressing strength required for dissolution before use to be low, the thickness difference present in the vicinity of the boundary between the two sealed portions is preferably 50 μm or less and more preferably 30 μm or less.

As the thickness difference present in the vicinity of the boundary between the two sealed portions, a maximum thickness and a minimum thickness in the vicinity of the two sealed portions may be measured to acquire a difference therebetween. Examples of a method of measuring the thickness include a well-known measurement method such as measurement using a micrometer or three-dimensional contactless shape scanner measurement. As the micrometer, a micrometer having an area with a measurement spot diameter of about q 3 to 5 mm may be used.

The vicinity of the boundary is an area in a range of 6 mm or less from the boundary between the two sealed portions, that is, in a range of 12 mm where the boundary is interposed.

Here, as a method of setting the thickness difference present in the vicinity of the boundary between the weak sealed portion 106 and the strong sealed portion 104 to be 50 μm or less, for example, assuming that the step of forming the weak sealed portion 106 is the first sealed portion forming step and the step of forming the strong sealed portion 104 is the second sealed portion forming step, the second sealed portion forming step is performed after the first sealed portion forming step, the second sealed portion forming step includes a second heat sealing step and a second cooling step after the second heat sealing step, in the second cooling step, a region including a region for forming the strong sealed portion is sandwiched in a cooling mold and cooled, and a clearance in the cooling mold is defined by a thickness of a flat portion of the weak sealed portion.

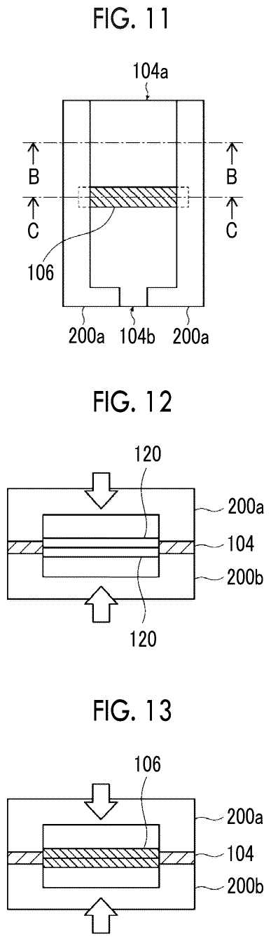

This method will be described using FIGS. 11 to 20.

In a case where the second sealed portion forming step is performed after forming the weak sealed portion 106 in the first sealed portion forming step, first, in the second heat sealing step, as shown in FIGS. 11 to 13, a region for forming the strong sealed portion 104 of the two resin films 120 is sandwiched between a pressing member 200a for sealing and a pressing member 200b for sealing and heat-sealed.

FIG. 11 is a conceptual diagram showing the heat sealing step of the second sealed portion forming step. In addition, FIG. 12 is a cross sectional view taken along line B-B of FIG. 11. FIG. 13 is a cross sectional view taken along line C-C of FIG. 11. In FIG. 11, the weak sealed portion 106 is not recognized, but the corresponding region is hatched.

As shown in FIGS. 11 to 13, in the pressing members 200a and 200b for sealing, according to the region for forming the strong sealed portion 104, a region along the left and right end sides and a region along a part of the lower end side in FIG. 11 are formed to be convex toward the resin film 120, and only the region for forming the strong sealed portion 104 can be pressed. In addition, although not shown in the drawing, the pressing members 200a and 200b for sealing include a heating device that heats the convex portion.

In the second heat sealing step, the two resin films 120 are pressed (hot-pressed) by the pressing member 200a for sealing and the pressing member 200b for sealing. Since the two resin films 120 are heated and pressed, a pressed region may be deformed to have a smaller thickness than the thickness before pressing.

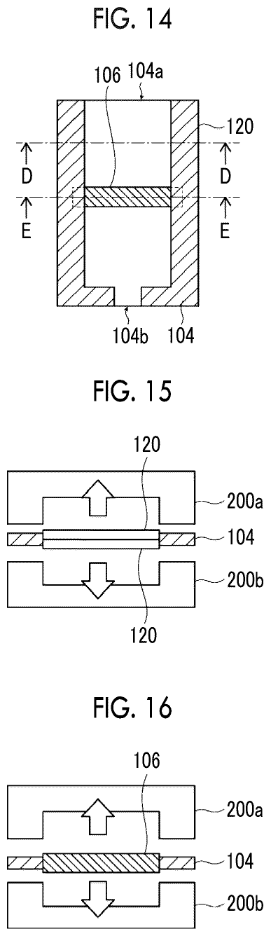

After performing heat sealing at a predetermined temperature and a predetermined pressing strength for a predetermined time, as shown in FIGS. 14 to 16, the pressing (hot-pressing) by the pressing members 200a and 200b for sealing is released. FIG. 14 is a conceptual diagram showing a state after the heat sealing step of the second sealed portion forming step. In addition, FIG. 15 is a cross sectional view taken along line D-D of FIG. 14. FIG. 16 is a cross sectional view taken along line E-E of FIG. 14. In FIG. 14, each of regions corresponding to the strong sealed portion 104 and the weak sealed portion 106 is hatched.

As shown in FIGS. 15 and 16, immediately after releasing the hot-pressing, the pressed region has a smaller thickness than the original thickness (other portion). FIG. 14 does not show the pressing members 200a and 200b for sealing.

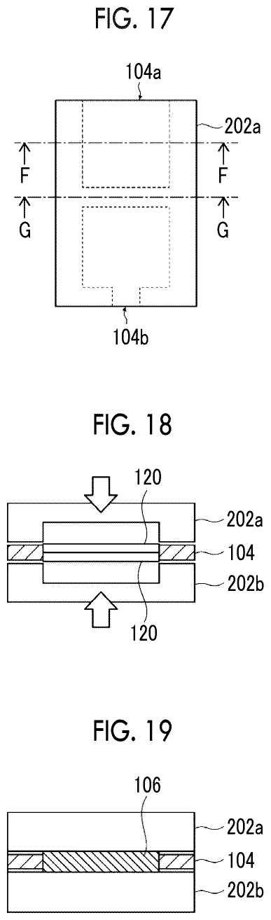

Next, as shown in FIGS. 17 to 19, a second cooling step of sandwiching a region including the region for forming the strong sealed portion 104 between cooling molds 202a and 202b and cooling the region is performed. FIG. 17 is a conceptual diagram showing the second cooling step of the second sealed portion forming step. In addition, FIG. 18 is a cross sectional view taken along line F-F of FIG. 17. FIG. 19 is a cross sectional view taken along line G-G of FIG. 17.

In the example shown in the drawing, the cooling molds 202a and 202b include a convex portion that is convex toward the resin film 120 and correspond to the entire region for forming the strong sealed portion 104 and the entire region for forming the weak sealed portion 106. In addition, although not shown in the drawing, the cooling molds 202a and 202b include a cooling device that cools the convex portion.

In this case, as shown in FIG. 19, the cooling molds 202a and 202b abut against the weak sealed portion 106, and a clearance between the cooling mold 202a and the cooling mold 202b is the same as the thickness of the weak sealed portion 106.

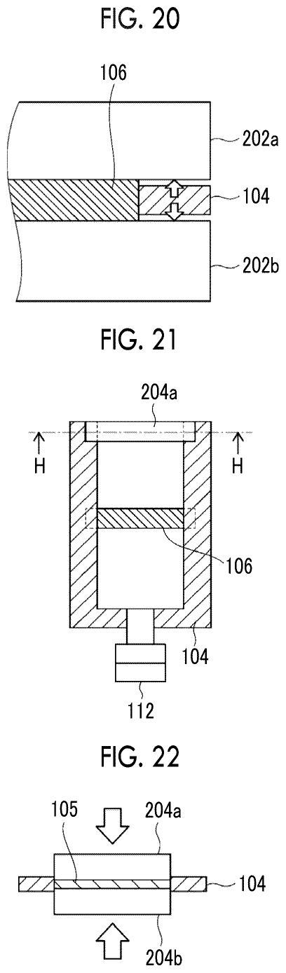

FIG. 20 is a partially enlarged view showing the vicinity of the boundary between the strong sealed portion and the weak sealed portion in FIG. 19.

The hot-pressed portion is melted, and in a case where the hot-pressed portion is left to stand, the hot-pressed portion is rounded due to the surface tension. That is, in a case where the portion is melted and thinned by hot-pressing, as indicated by an arrow in FIG. 20, the portion is contracted in the width direction and is thickened in the thickness direction until cooling.

In addition, as shown in FIGS. 30 and 31, in a case where the region for forming the strong sealed portion 104 is hot-pressed, the resin of which the fluidity is increased by heat may flow toward the weak sealed portion 106 such that the vicinity of a boundary with the hot-pressed region swells to form a convex portion p. The convex portion p can be formed on both surfaces or one surface of the weak sealed portion 106.

FIGS. 30 and 31 are enlarged views showing the vicinity of the boundary in a state immediately before ending the hot-press of the region for forming the strong sealed portion or a state (hot and fluid state) immediately after releasing the hot-press.

This way, in a case where the hot-pressed portion is thickened or the convex portion p is formed during hot-pressing, a level difference is formed in the vicinity of the boundary such that the thickness difference increases. Therefore, in a case where the cover sheet is welded to the resin film, a thermal load needs to be applied at a higher temperature and a higher pressure for a longer time, and there is a problem in that the gas barrier performance decreases due to fracture of a barrier layer of the cover sheet, heat is applied to the weak sealed portion, or the bonding strength increases.

On the other hand, in the present invention, the clearance between the cooling mold 202a and the cooling mold 202b is defined to be substantially the same as the thickness of the weak sealed portion 106. As a result, even in a case where the hot-pressed portion (the region for forming the strong sealed portion 104) is thick, the hot-pressed portion is regulated and cooled by the cooling mold 202a and the cooling mold 202b, and thus is substantially the same as the thickness of the weak sealed portion 106.

In addition, even in a case where the hot-pressed portion is pressed by the cooling mold 202a and the cooling mold 202b after being contracted and deformed to be thick, the thick portion can be pressed and flow to be substantially the same as the thickness of the weak sealed portion 106.

In addition, the convex portion p formed by hot-pressing is heated to have fluidity immediately after hot-pressing. Therefore, by pressing the convex portion p with the cooling mold 202a and the cooling mold 202b, the convex portion p can be pressed and flow to be substantially the same as the thickness of the weak sealed portion 106.

Here, the thickness difference present in the vicinity of the boundary between the weak sealed portion 106 and the strong sealed portion 104 can be reduced to be 50 μm or less.

In a case where the clearance between the cooling mold 202a and the cooling mold 202b is defined, the thickness of the weak sealed portion 106 is the thickness of a flat portion excluding the convex portion p or the like, and is the thickness of a normal region of the weak sealed portion 106 defined during the formation of the weak sealed portion 106. Specifically, the flat portion may be a region at a distance of 2 mm or more from the boundary between the weak sealed portion 106 and the strong sealed portion 104.

In addition, in the example shown in FIGS. 17 to 19, the cooling molds 202a and 202b include the convex portion corresponding to the entire region for forming the strong sealed portion 104 and the entire region for forming the weak sealed portion 106. However, the present invention is not limited to this configuration. For example, a surface on the resin film 120 side may be a flat surface.

In addition, as a method of setting the thickness difference present in the vicinity of the boundary portion between the strong sealed portion 104 and the opening closed-sealed portion 105 to be 50 μm or less, for example, assuming that the step of forming the strong sealed portion 104 is the second sealed portion forming step and the step of forming the opening closed-sealed portion 105 is the third sealed portion forming step, the third sealed portion forming step is performed after the second sealed portion forming step, the third sealed portion forming step includes a third heat sealing step and a third cooling step after the third heat sealing step, in the third cooling step, a region including a region for forming the opening closed-sealed portion is sandwiched in a cooling mold and cooled, and a clearance in the cooling mold is defined by a thickness of a flat portion of the strong sealed portion.

This method will be described using FIGS. 21 to 27.

In a case where the third sealed portion forming step is performed after forming the strong sealed portion 104 in the second sealed portion forming step, first, in the third heat sealing step, as shown in FIGS. 21 and 22, a region for forming the opening closed-sealed portion 105 of the two resin films 120 is sandwiched between a pressing member 204a for sealing and a pressing member 204b for sealing and heat-sealed.

FIG. 21 is a conceptual diagram showing the heat sealing step of the third sealed portion forming step. In addition, FIG. 22 is a cross sectional view taken along line H-H of FIG. 21. In FIG. 21, each of regions corresponding to the strong sealed portion 104 and the weak sealed portion 106 is hatched.

As shown in FIGS. 21 and 22, the pressing members 204a and 204b for sealing have a shape where a region extending along the upper end side in FIG. 21 is pressed according to the region for forming the opening closed-sealed portion 105, and press only the region for forming the opening closed-sealed portion 105. In addition, although not shown in the drawing, the pressing members 204a and 204b for sealing include a heating device that heats the pressed portion.

In the third heat sealing step, the two resin films 120 are pressed (hot-pressed) by the pressing member 204a for sealing and the pressing member 204b for sealing.

The pressed region may be thinner than the strong sealed portion 104 as in the example shown in FIG. 22. Alternatively, for example, in a case where a sterilization treatment is performed before forming the opening closed-sealed portion 105, the region for forming the opening closed-sealed portion 105 may be thicker than the strong sealed portion 104. In this case, even in a case where hot-pressing is performed, the region for forming the opening closed-sealed portion 105 is thicker than the strong sealed portion 104 as it is.

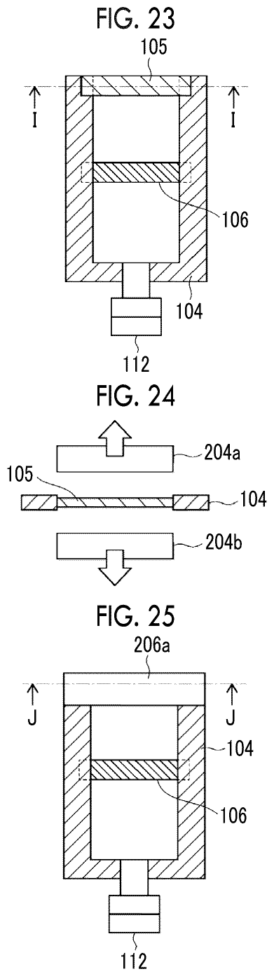

After performing heat sealing at a predetermined temperature and a predetermined pressing strength for a predetermined time, as shown in FIGS. 23 and 24, the pressing (hot-pressing) by the pressing members 204a and 204b for sealing is released. As shown in FIG. 24, immediately after releasing the hot-pressing, the pressed region has a smaller thickness than the original thickness (other portion). FIG. 23 does not show the pressing members 204a and 204b for sealing.

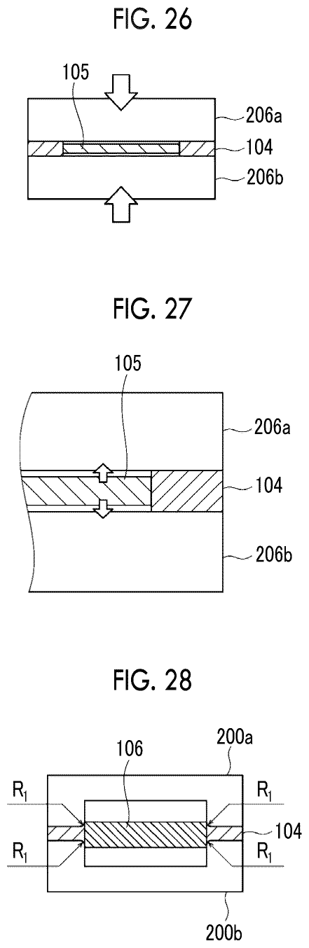

Next, as shown in FIGS. 25 and 26, a third cooling step of sandwiching a region including the region for forming the opening closed-sealed portion 105 between cooling molds 206a and 206b and cooling the region is performed. In the example shown in the drawing, the cooling molds 206a and 206b have a shape corresponding to the entire region for forming the opening closed-sealed portion 105 and a region including a part of the strong sealed portion 104. In addition, although not shown in the drawing, the cooling molds 206a and 206b include a cooling device that cools the pressed portion.

In this case, as shown in FIG. 26, the cooling molds 206a and 206b abut against the strong sealed portion 104, and a clearance between the cooling mold 206a and the cooling mold 206b is the same as the thickness of the strong sealed portion 104.

FIG. 27 is a partially enlarged view showing the vicinity of a boundary between the strong sealed portion and the opening closed-sealed portion in FIG. 26.

The hot-pressed portion is melted, and in a case where the hot-pressed portion is left to stand, the hot-pressed portion is rounded due to the surface tension. That is, in a case where the portion is melted and thinned by hot-pressing, as indicated by an arrow in FIG. 27, the portion is contracted in the width direction and is thickened in the thickness direction until cooling.

In addition, as in the example shown in FIGS. 30 and 31, in a case where the region for forming the opening closed-sealed portion 105 is hot-pressed, the resin of which the fluidity is increased by heat may flow toward the strong sealed portion 104 such that the vicinity of a boundary with the hot-pressed region swells to form a convex portion p. The convex portion p can be formed on both surfaces or one surface of the strong sealed portion 104.

This way, in a case where the hot-pressed portion is thickened or the convex portion p is formed during hot-pressing, a level difference is formed in the vicinity of the boundary such that the thickness difference increases. Therefore, in a case where the cover sheet is welded to the resin film, a thermal load needs to be applied at a higher temperature and a higher pressure for a longer time, and there is a problem in that the gas barrier performance decreases due to fracture of a barrier layer of the cover sheet, heat is applied to the weak sealed portion, or the bonding strength increases.

On the other hand, in the present invention, the clearance between the cooling mold 206a and the cooling mold 206b is defined to be substantially the same as the thickness of the strong sealed portion 104. As a result, even in a case where the hot-pressed portion (the region for forming the opening closed-sealed portion 105) is thick, the hot-pressed portion is regulated and cooled by the cooling mold 206a and the cooling mold 206b, and thus is substantially the same as the thickness of the strong sealed portion 104.

In addition, even in a case where the hot-pressed portion is thicker than the strong sealed portion 104 and is pressed by the cooling mold 202a and the cooling mold 202b, the thick portion can be pressed and flow to be substantially the same as the thickness of the strong sealed portion 104.

In addition, the convex portion p formed by hot-pressing is heated to have fluidity immediately after hot-pressing. Therefore, by pressing the convex portion p with the cooling mold 206a and the cooling mold 206b, the convex portion p can be pressed and flow to be substantially the same as the thickness of the strong sealed portion 104.

Here, the thickness difference present in the vicinity of the boundary between the strong sealed portion 104 and the opening closed-sealed portion 105 can be reduced to be 50 μm or less.

In a case where the clearance between the cooling mold 206a and the cooling mold 206b is defined, the thickness of the strong sealed portion 104 is the thickness of a flat portion excluding the convex portion p or the like, and is the thickness of a normal region of the strong sealed portion 104 defined during the formation of the strong sealed portion 104. Specifically, the flat portion may be a region at a distance of 2 mm or more from the boundary between the strong sealed portion 104 and the opening closed-sealed portion 105.

In the above-described example, in the second sealed portion forming step of forming the strong sealed portion 104, the clearance in a case where the region including for forming the strong sealed portion 104 is cooled by the cooling molds 202a and 202b in the second cooling step is defined by the thickness of the weak sealed portion 106, and in the third sealed portion forming step of forming the opening closed-sealed portion 105, the clearance in a case where the region including for forming the opening closed-sealed portion 105 is cooled by the cooling molds 206a and 206b in the third cooling step is defined by the thickness of the strong sealed portion 104. As a result, the thickness difference present in the vicinity of the boundary between the weak sealed portion 106 and the strong sealed portion 104 is set to be 50 μm or less, and the thickness difference present in the vicinity of the boundary between the strong sealed portion 104 and the opening closed-sealed portion 105 is set to be 50 μm or less. However, the present invention is not limited to this configuration. For example, in the second sealed portion forming step of forming the strong sealed portion 104, the clearance in a case where the region including for forming the strong sealed portion 104 is cooled by the cooling molds 202a and 202b in the second cooling step may be defined by the thickness of the weak sealed portion 106 such that the thickness difference present in the vicinity of the boundary between the weak sealed portion 106 and the strong sealed portion 104 to be 50 μm or less. In the third sealed portion forming step of forming the opening closed-sealed portion 105, the clearance in a case where the region including for forming the opening closed-sealed portion 105 is cooled by the cooling molds 206a and 206b in the third cooling step may be defined by the thickness of the strong sealed portion 104 such that the thickness difference present in the vicinity of the boundary between the strong sealed portion 104 and the opening closed-sealed portion 105 is set to be 50 μm or less.

Here, as shown in FIG. 28, it is preferable that, in the pressing members 200a and 200b for sealing used in the second heat sealing step of the second sealed portion forming step, a corner of the convex portion on the weak sealed portion 106 side is R-chamfered or C-chamfered. As a result, the weak sealed portion 106 and the strong sealed portion 104 are smoothly connected through the boundary portion. Therefore, the influence of the level difference can be reduced.

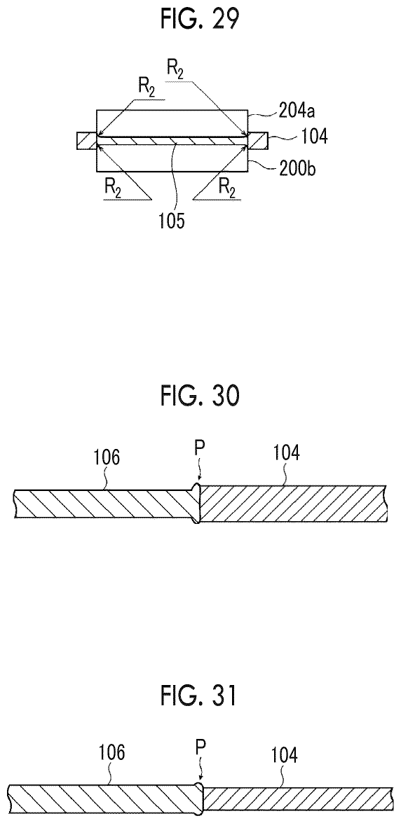

Likewise, as shown in FIG. 29, it is preferable that, in the pressing members 204a and 204b for sealing used in the third heat sealing step of the third sealed portion forming step, a corner on the strong sealed portion 104 side is R-chamfered or C-chamfered. As a result, the strong sealed portion 104 and the opening closed-sealed portion 105 are smoothly connected through the boundary portion. Therefore, the influence of the level difference can be reduced.

Hereinbefore, the method of manufacturing a before-use dissolution infusion bag according to the embodiment of the present invention has been described in detail. However, the present invention is not limited to the above-described aspects and various improvements and changes may be made within a range not departing from the scope of the present invention.

### EXAMPLES

Hereinafter, the present invention will be described in detail using Examples. The present invention is not limited to specific examples described below.

### Example 1

In Example 1, a before-use dissolution infusion bag was prepared in the procedure shown in FIGS. 4 to 10.

### <Preparation of Resin Bag>

As a resin film, two polyethylene sheets for primarily packaging a drug having a thickness of 200 μm were prepared.

Two resin films were laminated to form a weak sealed portion of 90 mm×15 mm extending in a lateral direction at a center position in a longitudinal direction. In this case, as a pressing member for sealing, a heat sealing bar described in Example 1 of JP2004-000476A was used to perform heat sealing at a sealing pressure of 0.39 MPa, a heat sealing temperature of 118° C., and a sealing time of 4 seconds.

Next, using the pressing member for sealing including the convex portion shown in FIGS. 11 to 13, a part of peripheral ends of the two resin films (a region excluding the opening and the port insertion hole) was heat-sealed to form a strong sealed portion. The width of the convex portion (strong sealed portion) was 20 mm. In addition, the strong sealed portion was formed such that the inner dimensions of a chamber on a side (opening closed-sealed portion side) into which a drug was put were 105 mm×75 mm and the inner dimensions of a chamber on a side (port side) into which a chemical liquid was put were 95 mm×110 mm.

In addition, a part of the strong sealed portion was formed to overlap the weak sealed portion. The heat sealing pressure was 0.3 MPa, the heat sealing temperature was 140° C., and the heat sealing time was 2 seconds.

Next, cooling was performed using the cooling mold shown in FIGS. 17 to 19 within 2 seconds from the heat sealing of the strong sealed portion. In this case, a clearance between the two cooling molds was defined by the thickness of the weak sealed portion. The pressing strength was 0.35 MPa, the cooling temperature was 40° C., and the cooling time was 4 seconds.

Next, the port was inserted into the port insertion hole and the periphery of the port was heat-sealed to join the port. Next, the inside of the chamber was filled with saline as a chemical liquid from the port, and the port was closed.

Next, using the pressing member for sealing including the convex portion shown in FIGS. 21 to 22, the opening of peripheral ends of the two resin films was heat-sealed to form an opening closed-sealed portion. The width of the opening closed-sealed portion was 20 mm. In addition, a part of the opening closed-sealed portion was formed to overlap the strong sealed portion. The heat sealing pressure was 0.3 MPa, the heat sealing temperature was 140° C., and the heat sealing time was 2 seconds.

Next, cooling was performed using the cooling mold shown in FIGS. 25 and 26 within 2 seconds from the heat sealing of the opening closed-sealed portion. In this case, a clearance between the two cooling molds was defined by the thickness of the strong sealed portion. The pressing strength was 0.35 MPa, the cooling temperature was 40° C., and the cooling time was 4 seconds.

From the above, a resin bag was prepared.

In a region in the vicinity of a boundary between the weak sealed portion and the strong sealed portion of the prepared resin bag, the thickness of each of the weak sealed portion and the strong sealed portion was measured at three points using a micrometer (measurement spot diameter: 3 mm) to acquire a thickness difference between the maximum thickness and the minimum thickness.

Likewise, in a region in the vicinity of a boundary between the strong sealed portion and the opening closed-sealed portion, the thickness of each of the strong sealed portion and the opening closed-sealed portion was measured at three points using a micrometer (measurement spot diameter: 3 mm) to acquire a thickness difference between the maximum thickness and the minimum thickness.

The thickness difference present in the vicinity of a boundary between the weak sealed portion and the strong sealed portion was 30 μm. In addition, the thickness difference present in the vicinity of a boundary between the strong sealed portion and the opening closed-sealed portion was 40 μm.

### <Preparation of Cover Sheet>

A laminated film was prepared using the same method as that of a laminated film (laminated film including a gas barrier film and a resin film (sealant layer)) described in Example 1 of JP2012-218378A, except that the thickness of the resin film was 40 μm. The prepared laminated film was cut into 140 mm×115 mm.

### <Preparation of Before-Use Dissolution Infusion Bag>

The cut laminated film was thermally welded to both outer side surfaces of the chamber of the resin bag on the opening closed-sealed portion side. In this case, a colored nonvolatile liquid was dropped between the cover sheet and the resin bag, and was left to stand for 8 hours or longer after the thermal welding. By checking whether the colored liquid was bled out to the outside of the cover sheet to check whether or not leakage occurred, thermal welding (heat sealing) was performed under conditions where leakage did not occur.

As conditions of the thermal welding of the cover sheet and the resin bag, the heat sealing pressure was 0.35 MPa, the heat sealing temperature was 165° C., and the heat sealing time was 5 seconds.

From the above, a before-use dissolution infusion bag was prepared.

### Comparative Example 1

In the cooling step during the formation of the strong sealed portion and the formation of the opening closed-sealed portion, A before-use dissolution infusion bag was prepared using the same method as that of Example 1, except that the configuration was changed to a configuration where the cooling mold abutted against only the heat-sealed region and the conditions of thermal welding between the cover sheet and the resin bag were changed to conditions where there were no leakage.

The thickness difference present in the boundary portion between the weak sealed portion and the strong sealed portion was 80 μm. In addition, the thickness difference (average value) in the boundary portion between the strong sealed portion and the opening closed-sealed portion was 100 μm.

In a case where the thickness difference was generated in the boundary between the sealed portions, conditions of the thermal welding between the cover sheet and the resin bag where leakage did not occur were a heat sealing pressure of 0.35 MPa, a heat sealing temperature of 185° C., and a heat sealing time of 5 seconds.

### [Evaluation]

### <Gas Barrier Performance>

The inorganic layer of the cover sheet of the prepared before-use dissolution infusion bag was observed with an optical microscope (manufactured by Olympus Corporation) to check whether or not cracks were observed. The observation magnification was 50-fold.

In Example 1, cracks were not observed. Accordingly, it can be seen that high gas barrier performance was maintained. On the other hand, in Comparative Example 1, cracks were observed in the vicinity of the boundary between the sealed portions. Accordingly, it can be seen that the gas barrier performance decreased.

### <Peel Strength of Weak Sealed Portion>

The prepared before-use dissolution infusion bag was placed on a seat, this chamber was pressed using a smaller plate than the chamber into which a chemical liquid was put, and the weak sealed portion was peeled off such that the two chambers communicated with each other. In this case, the pressing strength was measured using a digital force gauge (manufactured by IMADA Co., Ltd.) and a measurement stand to acquire a peak strength. In addition, in Reference Example, the resin bag to which the cover sheet was not welded was prepared using the same method as that of Example 1, and the same measurement was performed.

The peak strength of Example 1 was within 120% of the peak strength of Reference Example. Accordingly, it can be seen that the pressing strength required for dissolution before use was able to be maintained to be low. On the other hand, the peak strength of Comparative Example 1 was 150% or more of the peak strength of Reference Example. Accordingly, it can be seen that the pressing strength required for dissolution before use was increased.

### EXPLANATION OF REFERENCES

10: cover sheet
100: before-use dissolution infusion bag
102: resin bag (bag body, infusion bag)
104: strong sealed portion
104A: opening
104b: port insertion hole
105: opening closed-sealed portion
106: weak sealed portion
108, 110: chamber
120: resin film
200a, 200b, 204a, 204b: pressing member for sealing
202a, 202b, 206a, 206b: cooling mold
W: chemical liquid
M: drug

What is claimed is:

1. A method of manufacturing a before-use dissolution infusion bag, the method comprising:
forming a chamber for sealing a content by performing, two or more times, a sealed portion forming step of laminating two resin sheets and bonding a part of the two resin sheets,
wherein a thickness difference present in the vicinity of a boundary between two sealed portions that are formed by different sealed portion forming steps and are in contact with each other is 50 μm or less, and
a welding step of welding a cover sheet to a region including a boundary portion between the two sealed portions is provided.

2. The method of manufacturing a before-use dissolution infusion bag according to claim 1,
wherein one of the two sealed portions is a weak sealed portion and the other sealed portion is a strong sealed portion having a higher bonding strength than the weak sealed portion,
a second sealed portion forming step of forming the strong sealed portion is performed after a first sealed portion forming step of forming the weak sealed portion,
the second sealed portion forming step includes a second heat sealing step and a second cooling step after the second heat sealing step,
in the second cooling step, a region including a region for forming the strong sealed portion is sandwiched in a cooling mold and cooled, and
a clearance in the cooling mold is defined by a thickness of a flat portion of the weak sealed portion.

3. The method of manufacturing a before-use dissolution infusion bag according to claim 1,
wherein one of the two sealed portions is a strong sealed portion and the other sealed portion is an opening closed-sealed portion,
a third sealed portion forming step of forming the opening closed-sealed portion is performed after a second sealed portion forming step of forming the strong sealed portion,
the third sealed portion forming step includes a third heat sealing step and a third cooling step after the third heat sealing step,
in the third cooling step, a region including a region for forming the opening closed-sealed portion is sandwiched in a cooling mold and cooled, and
a clearance in the cooling mold is defined by a thickness of a flat portion of the strong sealed portion.

4. The method of manufacturing a before-use dissolution infusion bag according to claim 1,
wherein the two sealed portions are a combination of a weak sealed portion and a strong sealed portion having a stronger bonding strength than the weak sealed portion and a combination of the strong sealed portion and an opening closed-sealed portion, respectively,
a first sealed portion forming step of forming the weak sealed portion, a second sealed portion forming step of forming the strong sealed portion, and a third sealed portion forming step of forming the opening closed-sealed portions are performed in this order,
the second sealed portion forming step includes a second heat sealing step and a second cooling step after the second heat sealing step,
in the second cooling step, a region including a region for forming the strong sealed portion is sandwiched in a second cooling mold and cooled,
a clearance in the second cooling mold is defined by a thickness of a flat portion of the weak sealed portion,
the third sealed portion forming step includes a third heat sealing step and a third cooling step after the third heat sealing step,
in the third cooling step, a region including a region for forming the opening closed-sealed portion is sandwiched in a third cooling mold and cooled, and
a clearance in the third cooling mold is defined by a thickness of a flat portion of the strong sealed portion.

5. The method of manufacturing a before-use dissolution infusion bag according to claim 4,
wherein the strong sealed portion is formed such that a part of peripheral ends of the two resin sheets is opened,
the opening closed-sealed portion is formed such that the opening of the peripheral ends of the two resin sheets is bonded, and
the weak sealed portion is formed such that a space sealed by the strong sealed portion and the opening closed-sealed portion is partitioned into two regions.
